(19) United States
(12) Patent Application Publication
(10) Pub. No.: US 2026/0153837 A1
(43) Pub. Date: Jun. 4, 2026

(54) METHOD FOR MANUFACTURING AN ESCAPEMENT PALLET

(71) Applicant: NIVAROX-FAR S.A., Le Locle (CH)

(72) Inventors: Guillaume TOUSSAINT, Morteau (FR); Frédéric HAEFELI, Tramelan (CH)

(73) Assignee: NIVAROX-FAR S.A., Le Locle (CH)

(21) Appl. No.: 19/363,894

(22) Filed: Oct. 21, 2025

(30) Foreign Application Priority Data
Dec. 4, 2024 (EP) 24217355.7

(51) Int. Cl. G04B 15/14

(52) U.S. Cl. CPC G04B 15/14

(57) ABSTRACT

A method for manufacturing a pallet for an escapement system.

### CROSS REFERENCE TO RELATED APPLICATIONS

This application claims priority to European Patent Application No. 24217355.7, filed on Dec. 4, 2024, the entire contents of which are incorporated herein by reference.

### Technical Field of the Invention

The invention relates to the field of horology. More specifically, it relates to a method for manufacturing a horology component, in particular an escapement pallet for a timepiece.

### Technological Background

In the field of horology, some applications require the use of complex components that need numerous machining operations.

Such is the case, for example, with pallets, which require numerous machining operations using several machines during laser blanking. Such a method can require parts to be corrected after their manufacture, which is costly and time-consuming.

Escapement pallets can also be manufactured by stamping, but for small production runs this method is very expensive and therefore of little interest.

One of the purposes of the present invention is therefore to provide a simpler manufacturing method making it possible to limit the number of corrected parts, while keeping the number of machines required for machining the pallets to one.

### SUMMARY OF THE INVENTION

To this end, the present invention relates to a method for manufacturing a pallet for an escapement system.

According to the invention, the method comprises the following steps:
a) taking a metal or metal alloy strip and forming guide holes in the strip to guide the strip;
b) milling into the strip to form horns;
c) making a bevel to form the body of the pallet, with a first end comprising the horns and a second end comprising two arms, the bevel being made over a portion of the thickness of the strip, such that the body of the pallet is still attached to the strip;
d) milling the outer shell of the pallet body, the milling being carried out in the portion of the thickness of the strip as in the
previous step;
e) milling an ebauche of a notch in each of the arms, each of the notches serving to receive a pallet stone, and, in the same step, milling an ebauche of the fork;
f) correcting the notches and the fork using a broaching tool;
g) laser blanking the resulting pallet in the thickness of the remaining strip to separate the pallet from the strip.

According to other advantageous variants of the invention:
in step f), the broaching is carried out only in an axial direction;
in step f), at least two lateral passes are carried out to produce a specific width;
in step e), a staff hole and a dart hole are also pierced;
in step e), the milling is carried out through the entire thickness of the strip;
the method comprises a step h) in which pallet stones and a staff are fitted to the pallet;
the broaching tool is made of hard metal.

The invention also relates to a pallet for an escapement system obtained using the method according to the invention.

### BRIEF DESCRIPTION OF THE DRAWINGS

Other characteristics and advantages of the invention will become apparent from the detailed description below, with reference to the accompanying drawings, in which:

FIG. 1 shows a pallet obtained by the method according to the invention;

FIGS. 2 to 6a illustrate the various steps in the manufacturing method according to the invention.

### DETAILED DESCRIPTION OF THE INVENTION

The invention relates to a method for manufacturing a pallet for an escapement system.

The pallet 1 generally comprises a rod 2 formed of a metal material which can be, for example, carbon steel (for example, 20AP, 15P, Ck75 or Ck101), titanium, aluminium, an austenitic cobalt-based alloy, a brass alloy (for example, CuZn42) , or a copper alloy (for example, CuBe2 or German silver (CuNi1820)).

The rod 2 comprises arms 20 and 21 provided to support the pallet stones so as to engage with at least one escapement wheel (not shown) in an escapement system. Between these two arms 20 and 21, a pallet staff is fitted in a hole 22 in order to pivotally mount the pallet 1. Lastly, at the end opposite arms 20, 21, the rod 2 comprises a fork 5 with two horns 50, 51.

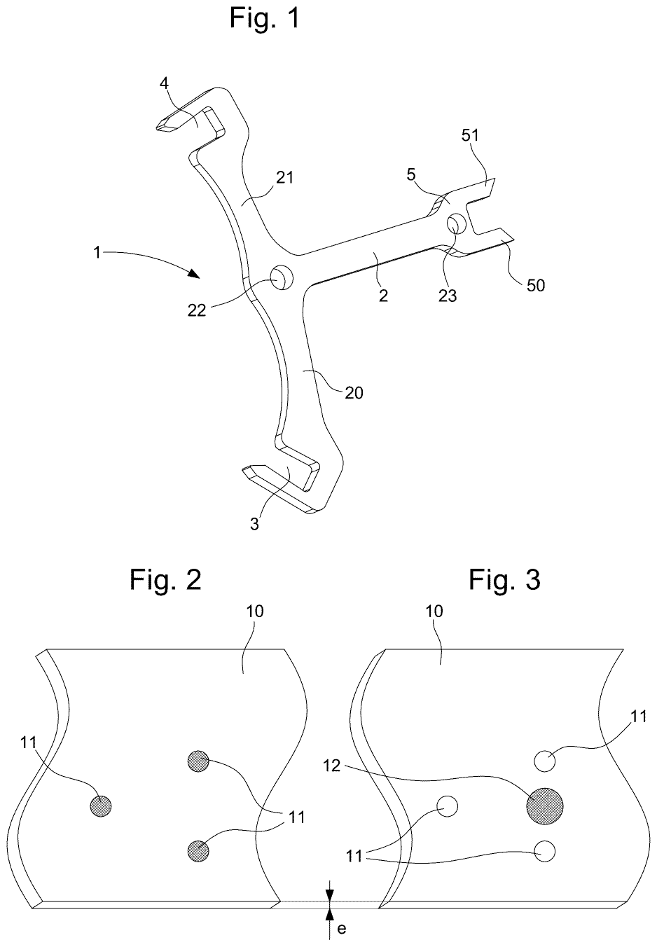

In the example illustrated in FIG. 1, a conventional pallet for a timepiece can be seen. Of course, other types of pallets, such as a side pallet, can be manufactured using the method described hereinafter.

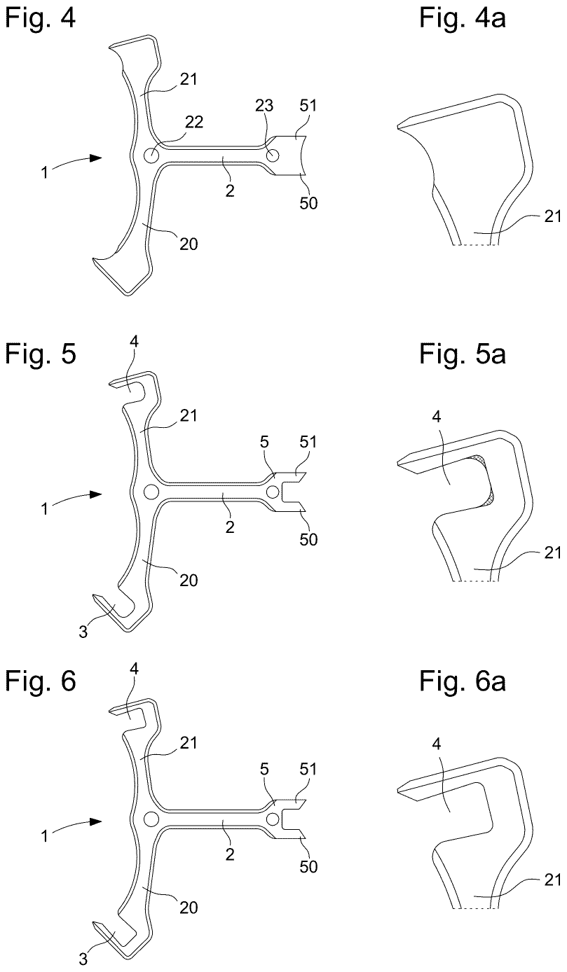

The pallet manufacturing method 1 according to the invention will now be described with reference to FIGS. 2 to 6a.

The first step a) in the method, illustrated in FIG. 2, consists of taking a metal or metal alloy strip 10 of thickness e, in which guide holes 11 are blanked to guide and move the strip 10 along a conveyor (not shown in the figures).

The next step b), illustrated in FIG. 3, consists of milling 12 into the strip 10, the milling 12 being carried out to a depth that is less than the thickness e of the strip and at least half the thickness e of the strip, to form the horns 50, 51 of the pallet.

The third step c) in the method, illustrated in FIGS. 4 and 4a, consists of making a bevel to form the body of the pallet, with a first end comprising the horns 50, 51 and a second end comprising two arms 20, 21. The bevel is made to a depth equal to half the thickness e of the strip such that the body of the pallet is still attached to the strip at the end of the step.

The fourth step d) in the method consists of milling the outer shell of the pallet body, the milling also being carried out to a depth that is less than the thickness of the strip, and at least through two-thirds of the thickness e of the strip, in order to keep the pallet body attached to the strip.

The fifth step e), illustrated in FIGS. 5 and 5a, consists of milling an ebauche of a notch 3, 4 in each of the arms 20, 21, and, in the same step, milling an ebauche of the fork 5. In this step, the notches 3, 4 and the fork 5 are milled through the entire thickness e of the strip 10. In step e), a staff hole 22 and a dart hole 23 are also pierced.

The sixth step, f), illustrated in FIG. 6, consists of correcting the notches 3 and 4 and the fork 5 using a broaching tool. Broaching is carried out only in an axial direction, and at least two lateral passes are made to produce a predetermined width for the notches 3, 4. Such a step makes it possible to obtain the desired angles at the back of the notches, because milling does not enable the desired angles to be produced as the radius of the milling cutter is too large.

Lastly, the seventh step g) consists of laser blanking the resulting pallet in the thickness of the remaining strip to separate the pallet from the strip. Alternatively, the pallet can be separated from the strip using a stamp.

The method can also comprise a step h) in which pallet stones and a staff are fitted to the pallet.

The invention also relates to a pallet obtained according to the method according to the invention.

1. A method for manufacturing a pallet (1) for an escapement system, comprising the following steps:
a) taking a metal or metal alloy strip (10) with a thickness (e), and forming guide holes (11) in the strip (10) to guide the strip;
b) milling (12) into the strip (10), through at least half the thickness (e) of the strip (10), to form horns (50, 51);
c) making a bevel to form the body of the pallet (2), with a first end comprising the horns (50, 51) and a second end comprising
two arms (20, 21), the bevel being made over at least half the thickness (e) of the strip, such that the body of the pallet is still attached to the strip;
d) milling the outer shell of the pallet body (2), the milling being carried out through two-thirds of the thickness (e) of the strip;
e) milling, through the entire thickness (e) of the strip, an ebauche of a notch (3, 4) in each of the arms (20, 21), each of the notches (3, 4) serving to receive a pallet stone, and, in the same step, milling an ebauche of the fork (5);
f) correcting the notches (3, 4) and the fork (5) using a broaching tool; and
g) laser blanking the resulting pallet in the thickness of the remaining strip to separate the pallet from the strip.

2. The pallet manufacturing method according to claim 1, wherein in step f), the broaching is carried out only in an axial direction.

3. The pallet manufacturing method (1) according to claim 1, wherein in step f), at least two lateral passes are carried out to produce a specific width.

4. The pallet manufacturing method (1) according to claim 1, wherein in step e) a staff hole (22) and a dart hole (23) are also pierced.

5. The pallet manufacturing method (1) according to claim 1, wherein in step e) the milling is carried out through the entire thickness of the strip.

6. The pallet manufacturing method (1) according to claim 1, further comprising a step h) in which pallet stones and a staff are fitted.

7. The pallet manufacturing method (1) according to claim 1, wherein the broaching tool is made of hard metal.

8. A pallet (1) obtained by the method according to claim 1.
